(19) United States
(12) Patent Application Publication
(10) Pub. No.: US 2012/0246892 A1
(43) Pub. Date: Oct. 4, 2012

(54) BARREL NUT TYPE DECORATIVE ACCESSORY AND METHODS FOR ATTACHMENT TO DRAWSTRINGS

(76) Inventor: Warren Stevens, Charleston, WV (US)

(21) Appl. No.: 13/074,158

(22) Filed: Mar. 29, 2011

(51) Int. Cl. F16B 2/26

(52) U.S. Cl. 24/483

(57) ABSTRACT

Apparatus, systems and methods for the attachment of an accessory to a drawstring including a barrel member having an axially disposed, female compression cavity formed in one end defining an annular end-face and a pair of diametrically disposed feed through holes. The feed through holes are positioned axially along the body so as to intersect the barrel cavity above its base and are sized to receive and allow a drawstring or the like to pass into the barrel, through the barrel cavity and exit the barrel. The apparatus includes a male compression member dimensioned to fit within and frictionally engage and mate with the female compression cavity of the barrel member, the male compression member having a compression tip projecting distally of the feedthrough holes relative to the cavity opening. The length of the male compression member is less than that of the cavity, but upon insertion and frictional interlocking engagement of the male compression member into the cavity, the male member engages and compress a drawstring, extending diametrically through the feedthrough holes, positionally affixing the barrel on the drawstring.

### I. PRIORITY CLAIM

This application claims the benefit under 35 U.S.C. §120 of U.S. Non-provisional application Ser. No. 12/759,393 filed on Apr. 13, 2010, which is incorporated herein by reference.

### II. BACKGROUND OF THE INVENTION

This invention relates to an improvement in user selective decorative accessories and particularly, to user mountable and demountable decorative attachments for clothing string, drawstrings and the like and their use.

### III. DESCRIPTION OF THE TECHNICAL FIELD

Presently, numerous decorative beads, clips, and locks for strings on clothing such as drawstrings are well-known. Likewise fashion accessories for clothing such as studs and snap-fit buttons are well-known. One such recent fashion accessory is the ubiquitous Jibbitz® used in conjunction with CROCS® allowing the wearer to personalize the shoes with a favorite theme or character set.

Such an accessorizing adjunct adaptable to a full range of confirmations and artwork, for affixation to strings such as a sweatshirt or sweat pant drawstring, bikini string, or the like, however, has not yet been popularized,

The invention herein contemplates a barrel-type body with an axially disposed string receiving feedthrough (hole) positioned to permit compressing engagement of the string within the barrel to affix the barrel member on the string. The outer configuration of the barrel may assume any conformation or configuration and may feature artwork and coloration designated by a user based on taste in fashion or theme.

### IV. SUMMARY OF THE INVENTION

The invention relates to a structure and method for attachment of an accessory to a clothing string, drawstring, cord, or the like.

It is an object of the invention to provide a structure for attaching an accessory to a drawstring, or the like, that provides easy adjustment of the position of the accessory on the cord without having to removing the structure.

It is another object of the invention to provide a selectively attachable and removable ornamental element structure for attaching an accessory to a drawstring, or the like.

It is yet another aspect of the invention to provide a structure for attaching an accessory to a drawstring, or the like, that provides a means to easily incorporate electronic technology such as RFID.

It is a further object of the invention to provide a multi-piece structure for attaching an accessory to a drawstring, or the like, that avoids damaging the drawstring.

It is a further object of the invention to provide a structure for attaching an accessory to a drawstring, or the like, that provides for easy positional adjustment on the string.

It is another object of the invention to provide a structure for attaching an accessory to a drawstring, or the like, that is easily attached and detached from the drawstring.

It is yet another object of the invention to provide a structure for attaching an accessory to a drawstring, or the like, that is sufficiently rugged to withstand machine wash.

It is a further object of the invention to provide a structure for attaching an accessory to a drawstring, or the like, that is not subject to unintentional detachment.

It is a an additional object of the invention to provide a structure for attaching an accessory to a drawstring, or the like, that also includes supplemental mounting elements to attach additional items to the drawstring.

It is also an object of the invention to provide a structure for attaching an accessory to a drawstring, or the like, that includes provisions for attaching an item of jewelry or other ornamental accessories to a drawing.

It is an additional object of the invention to provide a multi piece cooperating structure for attaching an accessory to a drawstring, or the like, that avoids damaging the drawstring.

Certain of these and other objects a satisfied by an apparatus for the attachment of an accessory to a drawstring which in one embodiment includes a barrel member having an axially disposed, compression cavity formed in one end defining an annular end-face and a pair of diametrically disposed feed through holes. The feed through holes are positioned axially along the body so as to intersect the barrel cavity above its base and are sized to receive and allow a drawstring to pass into the barrel, through the barrel cavity and exit the barrel.

The apparatus of this embodiment includes a male compression member dimensioned to fit within and frictionally engage and mate with a female compression cavity of the barrel member, the compression member having a compression tip projecting distally of the feed through holes relative to the cavity opening. The length of the male compression member is less than that of the cavity, but upon insertion and frictional interlocking engagement of the male compression member into the cavity, engages and compresses a drawstring, extending diametrically through the feed through holes, positionally affixing the barrel on the string.

Still other objects are satisfied by an apparatus for the adjustable attachment of an accessory to a clothing string including a barrel member having a top and bottom section, the bottom section having an axially disposed, compression cavity formed therein defining an annular end-face and, a pair of diametrically disposed feed through holes positioned axially along the body intersecting the compression cavity above its base. The barrel member includes a plurality of molded keys disposed between the feed through holes and the cavity base, projecting radially from the cavity surface.

The top section of the barrel member includes another axially disposed, cavity formed in the top extending to the bottom cavity above the feed through holes, the top cavity having at least one groove extending axially substantially the length of the top cavity and a tongue and groove assembly disposed on the top end to receive and retain an end cap assembly.

Yet other objects are satisfied by incorporating a male compression member having a base, a smooth shaft and a compression tip, the base dimensioned to frictionally engage and mate with the female compression cavity of the barrel member. The compression tip projects distally from the threaded base relative to the cavity opening, past the feed through holes, and has a slightly greater diameter than the diameter of the interior cavity defined by the plurality of molded keys in the bottom section of the barrel member.

Objects of the invention, in part are satisfied by inclusion of an end cap assembly having a substantially smooth vertical shaft having at least one protrusion extending axially the length of the shaft corresponding to the axial groove in the barrel member top section. The end cap shaft is dimensioned complementary to the barrel cavity to fit therein in close registry therewith, and includes at least one tongue assembly disposed to engage the groove assembly of the barrel member when inserted into the top of the barrel member locking the end cap to the barrel. When the male compression member engages a drawstring passed through the feed through holes within the barrel cavity, the member compresses the drawstring against the end cap assembly, affixing the barrel to the drawstring.

For definitional purposes and as applicable the term “drawstring” as used herein is intended to mean any string, cord, strap, elongated structure, and the like whether non-elastic or elastic, rigid or flexible, attached or affixed to laced articles, bags, covers or any article of clothing such as jeans, sweat shirts, sweaters, hats, jackets, etc., typically disposed within an opening in a defined perimeter.

As used herein the term “click-type” locking mechanism relates to a structure characterized by a first element of an interlocking component that is positionable to bring into frictional engagement and to be in substantially cooperative registry with a second element. One or both of the cooperative elements have structure that engages structure of the opposing cooperating element which is interlockable and may be partially resiliently deformable due to forces incident thereon at a point during the assembly process. Preferably upon relaxation of the interlocking force incident on the deformeable structure, the structure returns to its original shape substantially seating the two cooperative elements into their relative orientation. Upon engagement of the first and second elements and the seating of their relative orientation to each other, a tactile and/or audible snap or click is produced.

The term “click adjustment” relates to an adjustment feature in which an adjustment range of the frictional pressure between two engaged components is indicated, through a series of audible or tactile clicks produced when the frictional pressure is increased or decreased by rotationally engaging the components relative to the other.

As used herein “connected” includes physical engagement, whether direct or indirect, permanently affixed or adjustably mounted. Thus, unless specified, “connected” is intended to embrace any operationally functional connection.

As used herein “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to the accompanying drawing which is shown by way of illustration to the specific embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

### V. BRIEF DESCRIPTION OF THE DRAWINGS

FIG. 1 is a partial cutaway view of an exemplarily embodiment of the invention.

FIG. 2 is a partial cross-sectional view of a barrel with a cavity corresponding to the first embodiment of FIG. 1.

FIG. 3 is a side view of a compression nut in accordance with the first embodiment of FIG. 1.

FIG. 4 is a top view of the barrel of FIG. 2 illustrating internal cavity threading.

FIG. 5 is a bottom view of the compression nut of FIG. 3.

FIG. 6 is a partial cutaway view of another embodiment of the invention configured to resemble an aluminum can.

FIG. 7 is a partial cross-sectional view of a barrel with a cavity corresponding to a embodiment of FIG. 6.

FIG. 8 is a side view of a threaded compression screw in accordance with the embodiment of FIG. 6.

FIG. 9 is a side view of an end cap assembly in accordance with the first embodiment of FIG. 6.

FIG. 10 is an assembly drawing of the assembled embodiment of FIG. 6.

FIG. 11 is an assembly drawing of the threaded compression screw of FIG. 8.

FIG. 12 shows an assembly drawing of the end cap assembly of FIG. 9.

FIG. 13 show a cut away view of the assembled three piece embodiment of the invention configured to resemble an aluminum can.

FIG. 14 shows a further embodiment of the two piece embodiment of the invention in the configuration of a heart.

FIG. 15 shows a further embodiment of the invention incorporating a pair of accessory mounting tabs.

FIG. 16 shows a perspective view of an embodiment of the band assembly incorporating an accessory mounting tab featuring a pivoting lock clip to secure the band assembly.

FIG. 17 shows a front view of the embodiment of the band assembly of FIG. 16 with the pivoting lock clip in the open position.

FIG. 18 shows a front view of an embodiment of the band assembly of FIG. 16 with the pivoting lock clip in the closed position.

FIG. 19 shows a perspective view of an embodiment of a band assembly incorporating O-rings and two threaded compression screws.

FIG. 20 shows a front view of the embodiment of the barrel assembly of FIG. 19 featuring a band assembly mounted thereon.

### VI. DETAILED DESCRIPTION OF THE EMBODIMENTS

Referring now to the figures, wherein like reference numbers denote like components, elements, or features through the various illustrated embodiments discussed in detail below, the invention is an apparatus, system and method for the attachment of an accessory to a clothing string, cord, drawstring, or the like. While specific implementations of the disclosed technology are discussed, it should be understood that this is done for illustration purposes only. A person skilled in the relevant art will recognize that other components and configurations may be used without departing from the spirit and scope of the invention.

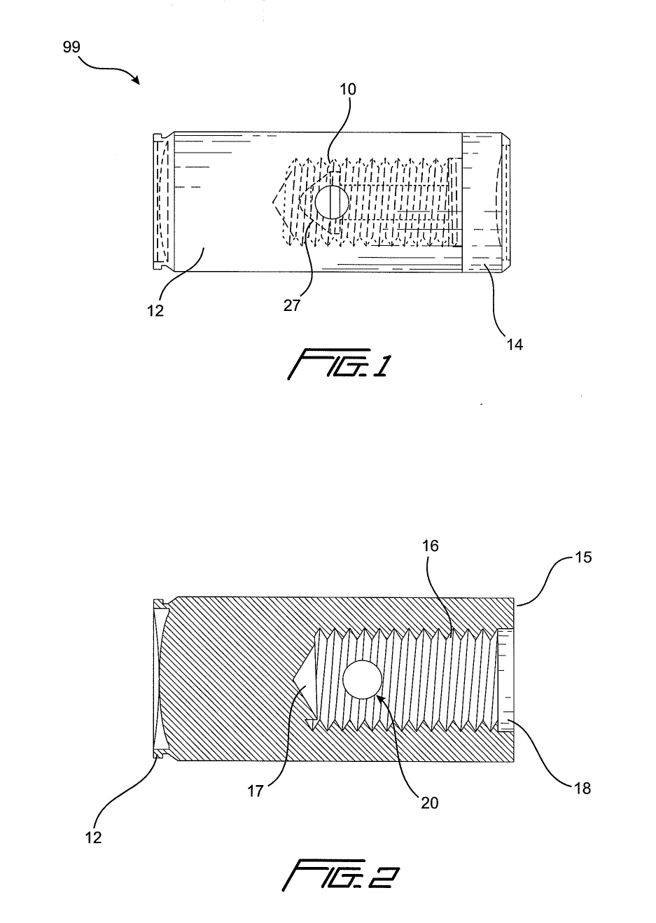

FIG. 1 illustrates a partial cutaway view of an exemplarily embodiment of the invention in a can, cylinder or barrel configuration. The embodiment shown in FIG. 1 features structure including a barrel member 12 and a threaded compression screw 14 dimensioned to screw into the barrel member 12. Both barrel member 12 and compression screw 14 threadably mate to form the barrel assembly 99.

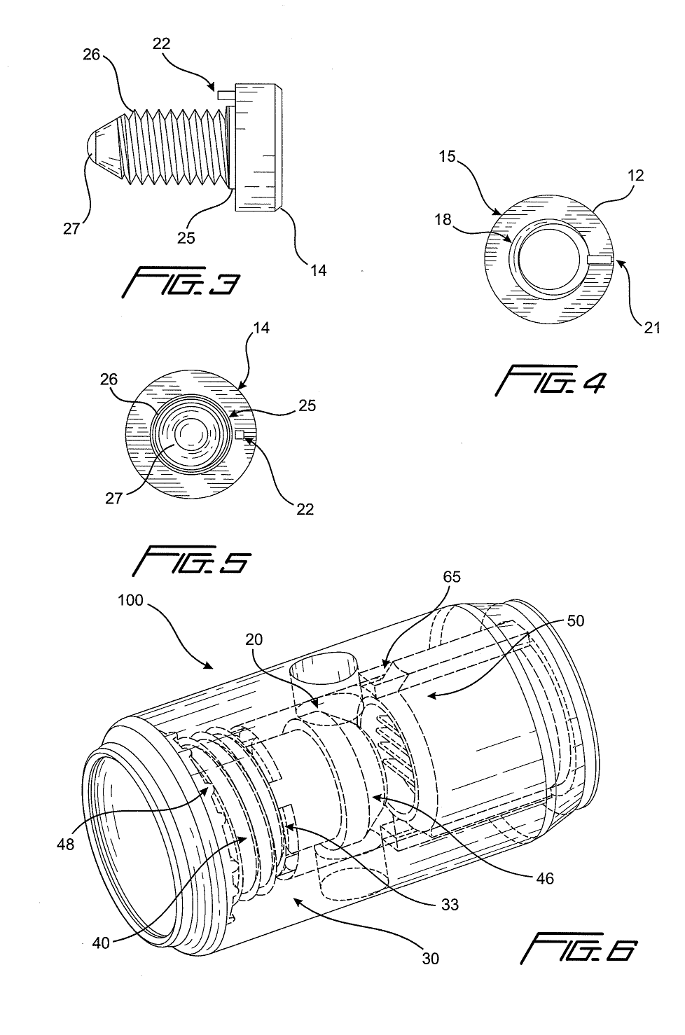

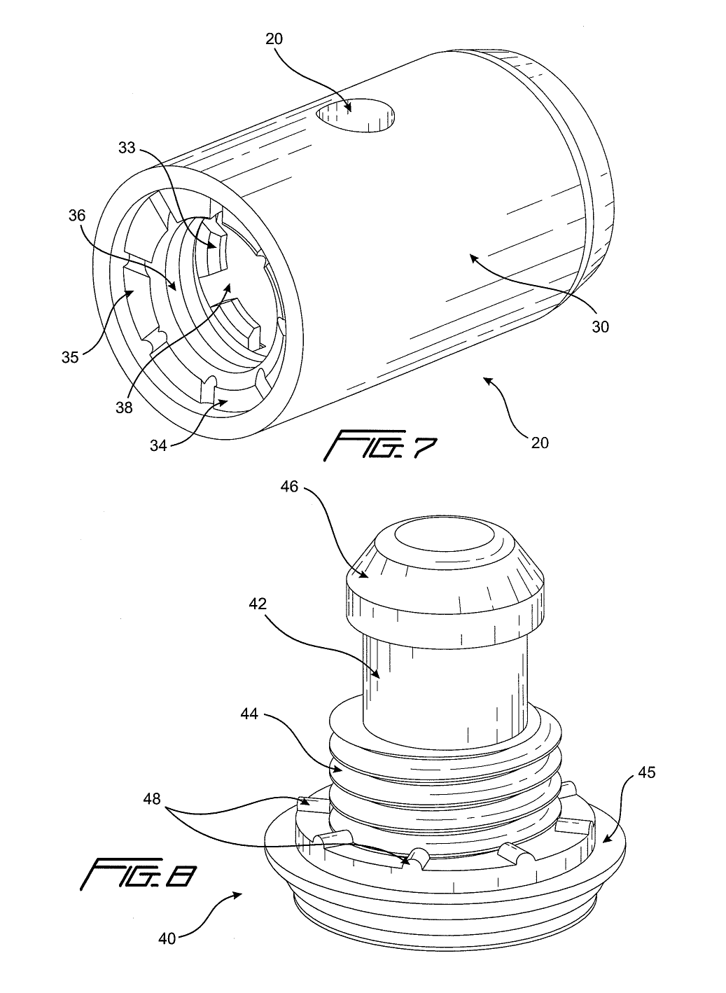

Referring now to FIG. 2 and FIG. 4, with continued reference to FIG. 1, the barrel member 12 features an axially disposed, female, threaded compression cavity 16 formed in one end defining an annular end-face 15. The exemplary structure illustrated in FIG. 2 also features a pair of diametrically disposed feed through or drawstring holes 20, positioned axially along the barrel body intersecting the barrel cavity 16 above its base. The feed through holes 20 are sized to receive and allow a drawstring (not shown) to pass into the barrel member 12, through the barrel cavity 16 and exit the barrel member 12.

FIGS. 3 and 5 show a compression screw 14 from the embodiment illustrated in FIG. 1. Referring to FIG. 3, with continued reference to FIGS. 1 and 2, the treaded compression screw 14 is dimensioned to fit within the barrel member's threaded compression cavity 16 and features a threaded shaft 26 configured to threadably mate with the threaded compression cavity 16. The compression screw 14 has a compression tip 27 projecting distally of the feed through holes 20 relative to the opening.

The length of the compression screw shaft 26 is less than that of the cavity 16, but upon threadable engagement and insertion of the compression screw 14 into the cavity 16, the screw tip 27 engages and compress a drawstring (not shown) passed through the feed through holes 20 at the cavity base 17.

The compression of the drawstring against the cavity base 17, by the compression screw 14, positionally affixes the barrel assembly 99 to the drawstring. The position of the barrel assembly 99 on the drawstring is adjusted by loosening (turning) the compression screw 14, to reduce the compression of or to disengage the drawstring, sliding the barrel assembly 99 to the desired position on the drawstring, and retightening the compression screw 14 to again engage and compress the drawstring.

The compression screw 14 shown in the instant embodiment features a head that corresponds in shape and circumference to the barrel body 12 and includes a stop ring 25 to abut a corresponding stop lip 18 formed at the top of the barrel cavity 16. This structure prevents over tightening and resultant damage to the barrel assembly 99 or the compressed drawstring.

The compression screw 14 may include a trough, bearing, rounded end, or other structural feature associated with the compression tip 27 to facilitate non-damaging compression of the engaged drawstring.

The illustrated compression screw 14 features a head having at least one dimple 22 disposed on the stop ring and a barrel body including at least one groove 21, corresponding to the dimple 22 on the stop ring, disposed on the stop lip. Upon threadable engagement of the barrel 12 and the compression screw 14 the dimple 22 on the screw 14 engages the groove 21 on the barrel 12 seating the compression screw 14 to the barrel 12 and preventing the inadvertent separation of the compression screw 14 and barrel 12.

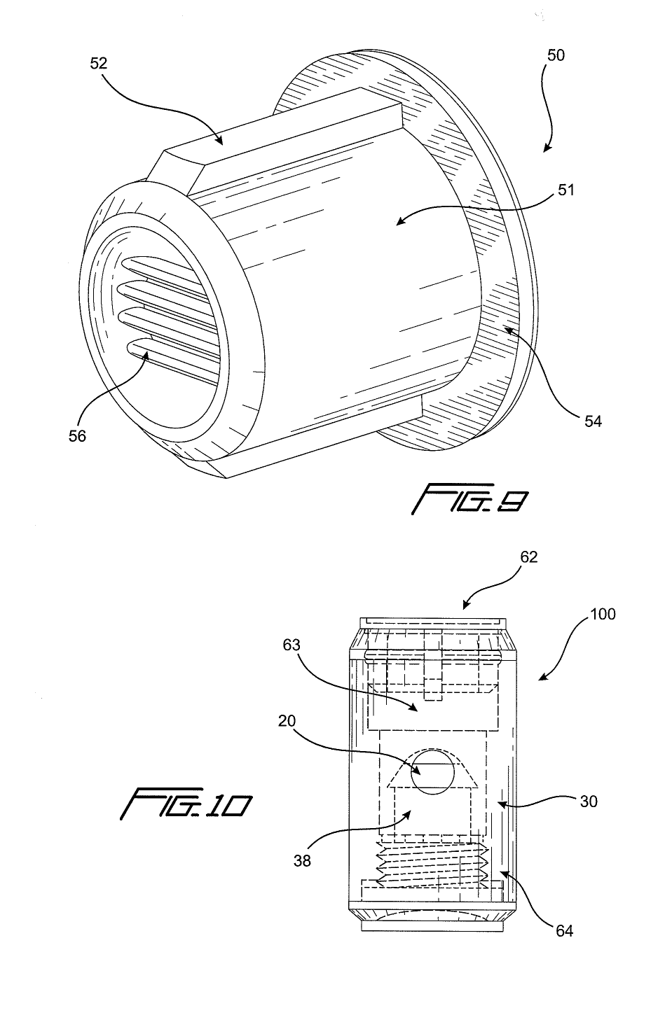

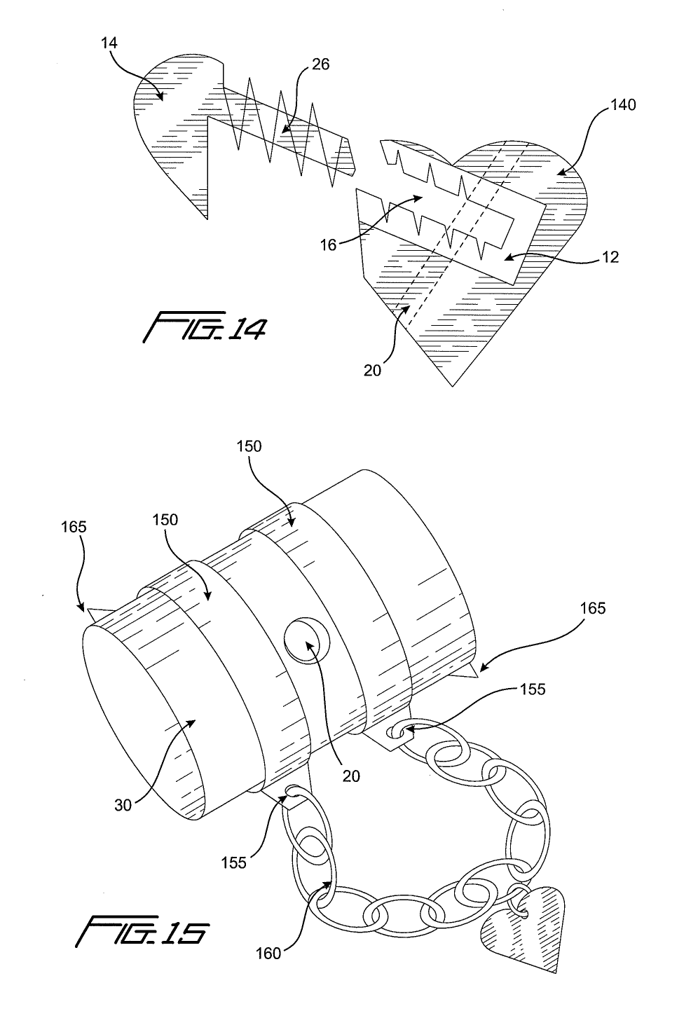

FIG. 6 illustrates a partial cutaway view of a three piece embodiment of the adjustable barrel assembly 100 in a configuration representing a beverage can. This embodiment includes a barrel member 30, a threaded compression screw 40 and an end cap assembly 50. FIG. 10 shows an assembly drawing of this embodiment. This embodiment also includes structure incorporating a compression click-type locking mechanism to prevent unintended or inadvertent disassembly and provide for ease of adjustment. Referring to FIG. 7, with continued reference to FIGS. 6 and 10, the barrel member 30 features top and bottom sections 62, 64. The bottom section 64 features an axially disposed, threaded compression cavity 38 formed therein, defining an annular end-face 35, as well as a pair of diametrically disposed feed through holes 20. The feed through holes 20 are positioned axially along the body intersecting the compression cavity 38 above its base.

The barrel member 30 has a plurality of deformable molded keys 33 disposed below the feed through holes 20. The deformable molded keys 33 project radially from the compression cavity 38 surface. The keys 33 engage the compression screw tip 27 and provide a positive click-lock engagement when the compression keys 33 engage the compression screw 40 when the compression screw 40 is inserted into the barrel member 30 during assembly.

The top section 62 of the barrel member 30 has another axially disposed cavity 63, formed in the top and extending to the bottom cavity 38 above the feed through holes 20. The top cavity 63 has at least one groove 65 extending axially, substantially the length of said top cavity 63, and a tongue and groove assembly disposed on the top end dimensioned to correspond to, receive, and retain an end cap assembly 50.

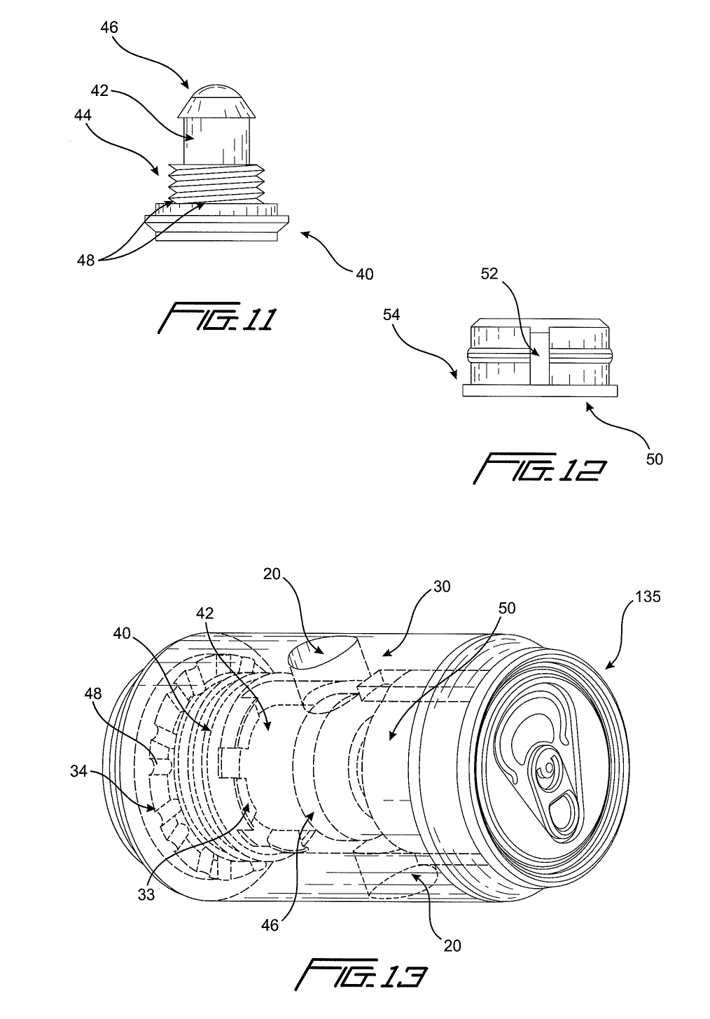

FIG. 8 illustrates the threaded compression screw 40. FIG. 11 illustrates an assembly drawing for the threaded compression screw 40. Referring now to FIGS. 8 and 11, the threaded compression screw 40 has a threaded base 44, a smooth shaft 42, and a compression tip 46. The threaded base 44 is dimensioned to threadably mate with the threaded compression cavity 38 of barrel member 30.

When inserted into and cooperatively frictionally engaged with the barrel member 30, the compression tip 46 projects distally from the threaded base 44 relative to the cavity opening 38, past the feedthrough holes 20 of the barrel member 30. The compression tip 46 features a slightly greater diameter than the diameter of the interior cavity defined by the plurality of resilient, deformable, molded keys 33 in the bottom section 64 of the barrel member 30. Upon assembly the compression screw tip's greater diameter deflects the deformable molded keys 33, momentarily compressing or deforming the molded keys 33 sufficiently to allow the compression screw tip to be inserted beyond the molded keys 33 and completely engage the threads 36 of the threaded compression chamber 38. Upon engagement the resilient keys 33 return to their undeformed configuration.

When the compression screw 40 is tightened, the compression tip 46 engages, deforms, and is forced past the deformable molded keys 33. The molded keys 33 return to their uncompressed position and rest adjacent to the smooth shaft 44 of the compression screw 40 and produces a tactile click when the compression screw 40 is seated into the barrel assembly 30. The diameter of the compression screw tip 46 is greater than the compression cavity's diameter, at the molded keys 33, and once inserted the compression screw 30 is difficult to inadvertently remove from the barrel 30. This positive click-type locking engagement, facilitated by the compression screw head's greater diameter, and the deformable molded keys 33 allows one to loosen the compression screw 40 for easily adjustment the assembly's position on the drawstring, while maintaining the seated engagement of the compression screw 40 and the barrel member 30. This feature prevents accidental disassembly of the barrel assembly 100 and subsequent unintentional or inadvertent removal of the barrel assembly 100 from the drawstring.

Referring now to FIG. 9 with continued reference to FIGS. 6 and 8, FIG. 9 shows an exemplary end cap assembly 50 for use with the barrel member 30 of FIG. 6. The end cap assembly 50 preferably has a substantially smooth vertical shaft 51 and at least one protrusion 52 extending axially the length of the shaft 51 corresponding to the axial groove 65 in the barrel member top section 63. The end cap shaft 51 is preferably sized to compress when inserted into the barrel assembly providing a tight fit within said barrel member top cavity 62 providing compression seating. The end cap 50 preferably has at least one tongue assembly disposed to engage the groove assembly of the barrel member 30 when inserted into the top of the barrel member 62 locking said end cap 50 to the barrel 30.

The end cap assembly 50 may also incorporate an identifier means, electronic, optical, magnetic or visual. The identifier means may be passive or active in operation. The end cap's electronic identifier means may be in the form of an RF identification chip or other electrical device generating an identifying signal.

In other embodiment the RF identification chip or other identifier means may be incorporated into a compartment formed in the male compression member 14 or compression screw 40.

Referring again to FIG. 6 with continued reference to FIGS. 7 and 8, when assembled the compression screw 40 engages a drawstring (not shown) passed through the feed through holes 20 within the barrel cavity 30. The compression screw tip 46 compresses the drawstring against the tip 56 of the end cap assembly 50, affixing the barrel assembly 100 to the drawstring. The bottom section of the barrel member 64 may include a plurality of locking grooves 34 formed in the exposed surface of the base thread 35 of the compression cavity 38.

In this exemplary embodiment the compression screw base 45 also includes at least one corresponding dimple lock 48 disposed on the surface of the base 45 adjacent to the threaded portion of the screw base 44. When the compression screw 40 and the barrel member 30 are threadably engaged and tightened the compression screw's dimple lock 48 engages the locking groove structure of barrel assembly 100, facilitating click adjustment of the engagement of compression screw 40 and the barrel 30. The locking groove structure engage the dimple locks 48 to provide frictional pressure on some of the compression screw and barrel member's engaging surfaces which secures and rotationally seats the compression screw 40 to said barrel 30. The dimple locks 48 and grooves are preferably disposed at consistent intervals to provide for a consistent range of click adjustments.

In other embodiments the bottom section of the barrel member may also include a stop ring and the compression screw head and a corresponding stop lip to prevent over tightening of the compression screw 40. The compression screw head stop ring has at least one dimple lock 48 disposed on the stop ring, and the barrel body includes at least one groove, corresponding to the dimple on the stop ring, disposed on the stop lip. Upon threadable engagement of the barrel 30 and screw 40 the dimple and groove engage to rotationally seat the compression screw to said barrel 30. In this embodiment the compression screw 40 may also incorporate a trough associated with the compression tip 46 to facilitate non-damaging compression on the engaged string.

In other embodiments the cooperative interaction between the male compression member and the female compression cavity, including the frictional engagement and seating of the male compression member to the barrel's compression cavity may be accomplished via the use of a channel locking, keeper key arrangements, tongue and groove arrangements, threaded arrangements, retaining ring arrangements, or other types of cooperative or mutual interlocking structures disposed on one or more of the engaging surfaces.

The exposed surfaces of said barrel member, the end cap, and compression screw when assembled form an ornamental shape for example an arrow, a heart, a diamond, or a sphere (ball, orb, planet, etc.). FIG. 13 shows an exemplary embodiment of the three-piece barrel assembly, in which the exposed surfaces of the assembled barrel member 30, end cap 50 and compression screw 40 form the shape of a soda can 135. In other embodiments the barrel member is contained within a housing structure where the housing structure has an ornamental shape, for example a ball, or a soda can or a whimsical shape such as a heart.

FIG. 14 illustrates another exemplary embodiment in which the barrel assembly 12 is contained within a housing structure 140 that has an ornamental shape. In this exemplarily embodiment the compression screw base 14 is formed in a shape to complement the ornamental shape of the housing 140 containing the barrel assembly 12. The compression screw 14 when engaged with the barrel assembly 12 combine with the housing 140 to resemble the shape of a heart.

The compression screw 14 features a head having at least one dimple disposed on the said stop ring, and said barrel body includes at least one groove, corresponding to said dimple on said stop ring, disposed on said stop lip, wherein upon threadable engagement of said barrel and said screw said at least one dimple and said at least one groove engage to prevent inadvertent disassembly (seating said compression screw to said barrel).

FIG. 15 illustrates yet another embodiment of the apparatus for the attachment of an accessory to a drawstring that incorporates supplemental mounts for additional items. Referring now to FIG. 15, this embodiment of the invention also includes a pair of band assemblies 150 that incorporate accessory mounting tabs 155 to receive additional accessories. The band assemblies 150 concentrically loop the barrel member 30 and affix the mounting tabs 155 to the barrel member 30. Preferably, when embodied as part of a band assembly the accessory mounting tabs 155 are demountable.

With continued reference to FIG. 15, the band assembly 150 concentrically loops the barrel member 30 and loosely engages the barrel member 30 to facilitate slidable adjustment. In embodiments having slidable adjustment, the barrel assembly typically incorporates structure to retain the band assembly 150 onto the barrel member 30. Barrel member 30 features a pair of protruding stop assemblies 165 that project from the barrel member's exterior surface. Preferably the stop assemblies 165 project beyond the diameter of the hoop of the band assembly 150, to limit the movement of the bands 150 along the exterior surface of the barrel member 30. The protruding stop assemblies 165 also function to define the range of slidable engagement of the band assembly 150 on the barrel member 30 in one or more plane of motion and facilitate quick and efficient adjustment of the position of the mounting tabs 155 relative to the barrel member 30. In other embodiments, the band assembly 150 engages the surface of the barrel member 30 with a clamping action and rigidly affixes the position of the mounting tabs 155.

Typically at least one corresponding pair of stop assemblies 165 are disposed on the exterior surface of the barrel member 30 proximate to the outside edges of each band 150 assembly and retain the band assembly 150 on the barrel member 30. The shape of the stop assemblies may vary and is not limiting.

The mounting tabs 155 typically include one or more holes therein sized to receive and engage an accessory or other assembly. As shown in FIG. 15, the mounting tabs 155 receive and engage an accessory chain 160 featuring a charm. In other embodiments the mounting tabs may be used to engage and mount chains, loops or strings to secure name tags, jewelry, keys, or any other accessory ornamental or functional in nature. The tabs 150 shown in the instant embodiment are not limited by shape and may be in the form of projections, booms, dowels, flanges, wedges, hooks, rings, etc., having a hole therein adapted to receive additional accessories. The band assemblies 150 and accessory mounting tabs 155 are equally applicable to 2 or 3 piece embodiments.

In other embodiments the invention resides an apparatus for attaching an accessory to a drawstring including a barrel lock assembly for attaching an accessory to a drawstring featuring a band assembly having top and bottom surface. The bottom surface of the band assembly defines the inner band ring and the inner ring is sized to receive a barrel lock assembly therethrough. The band assembly includes an accessory mounting tab formed on said top surface to facilitate the attachment of other accessories to the barrel lock assembly and ultimately the drawstring. The band assembly includes a pivoting joint, and a void formed in the top surface. The void defines a hole the extending through the band assembly surfaces.

The band assembly also includes a pivoting lock clip having a first edge and a second edge, and a seating element formed thereon proximate to the second edge protruding from a surface of said lock clip in the direction of the band assembly top surface. The pivoting lock clip is disposed proximate to the top surface of the band assembly where the first edge is secured to the pivoting joint formed on top surface of said band assembly such that the pivoting lock clip can rotationally pivot about the pivoting joint in plane defined by the band assembly between an open position and a closed position.

The seating element formed on the pivoting lock clip projects through the hole in the band assembly and into the inner band ring engaging a barrel lock assembly inserted in the band assembly and seats the band assembly to the barrel lock when the pivoting lock clips is in the closed position.

When the pivoting lock clip is in the open position the seating element formed on said pivoting lock clip does not protrude into the inner band ring allowing the band assembly to be moved or removed.

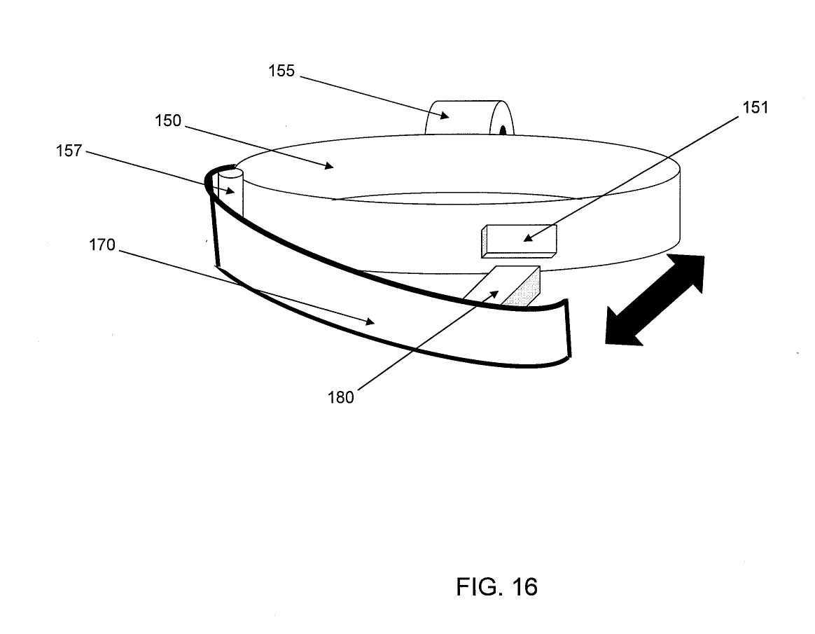

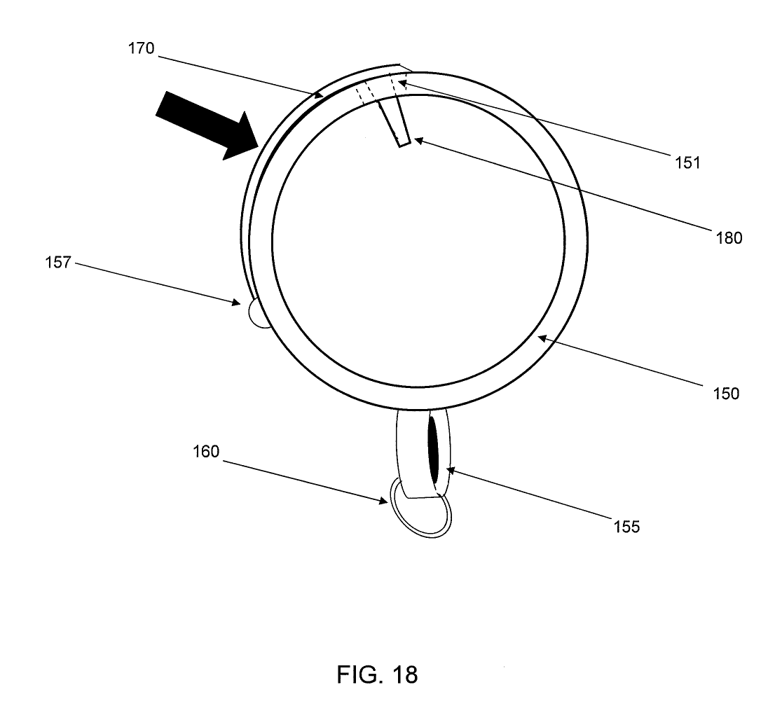

FIGS. 16, 17 and 18 illustrate this embodiment of the band assembly 150 with the incorporated accessory mounting tabs. Referring now to these FIGs., the band assembly 150 incorporates an accessory mounting tab 155 attached thereto for receiving and securing an accessory to the band assembly and ultimately the barrel member 30 (not shown). The band assembly 150 in this embodiment includes a pivoting lock clip 170 that is secured on one end to the band assembly 150 via hook and pin fasteners which cooperate to define a pivoting joint 157. Other embodiments may employ other fasteners. The pivoting joint 157 allows the pivoting lock clip 170 to pivot in relation to the band assembly's body. The band assembly 150 features a slot 151 formed therein, the slot 151 passing all the way through the band assembly's body creating a hole 151 therein adapted to receive a seating element. With particular reference to FIG. 18 with continued reference to FIG. 16, the pivoting lock clip 170 features a rod 180, or other seating element formed thereon which is disposed proximate to the slot 151 on the band assembly such that the rod 180 passes through the hole 151 formed in the band assembly 150, engages a surface of the barrel assembly (not shown) and ultimately seats the barrel assembly to the band assembly when the pivoting lock clip 170 is in the closed position. The barrel assembly is seated in the band assembly by the frictional forces of the seating element 180 against the barrel body.

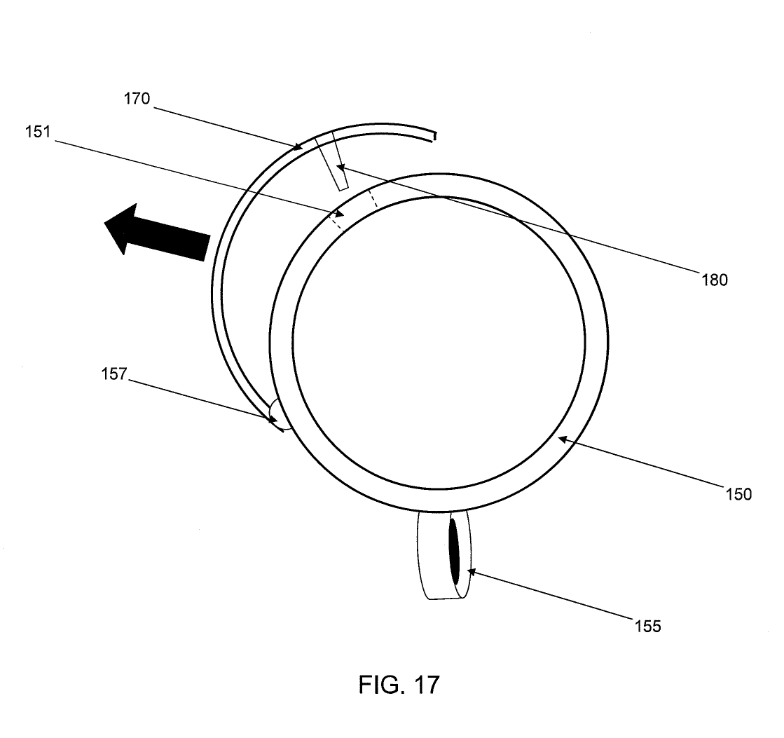

Referring now to FIG. 17 with continued reference to FIG. 16, when the pivoting lock clip 170 is in the open position the seating element 180 formed thereon does not protrude into the inner band ring allowing the band assembly 150 to be removed from or repositioned on the barrel assembly (not shown).

In other embodiments the bands may only partially loop or substantially loop the barrel member 30, or the bands may be employed to attach accessory tabs to the apparatus configured in a shape other than a barrel or cylinder shape. In yet other embodiments the bands may each include a plurality of mounting tabs 155, or the mounting tabs may be are molded or formed directly as part of the exterior surface of the barrel member 30, or may be directly mounted thereon by fasters or adhesives.

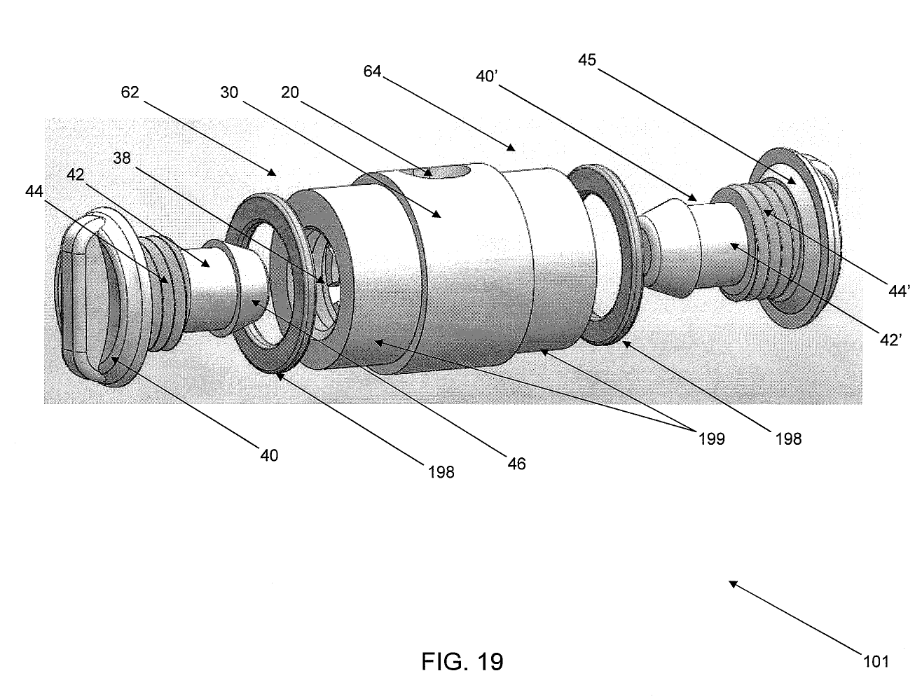

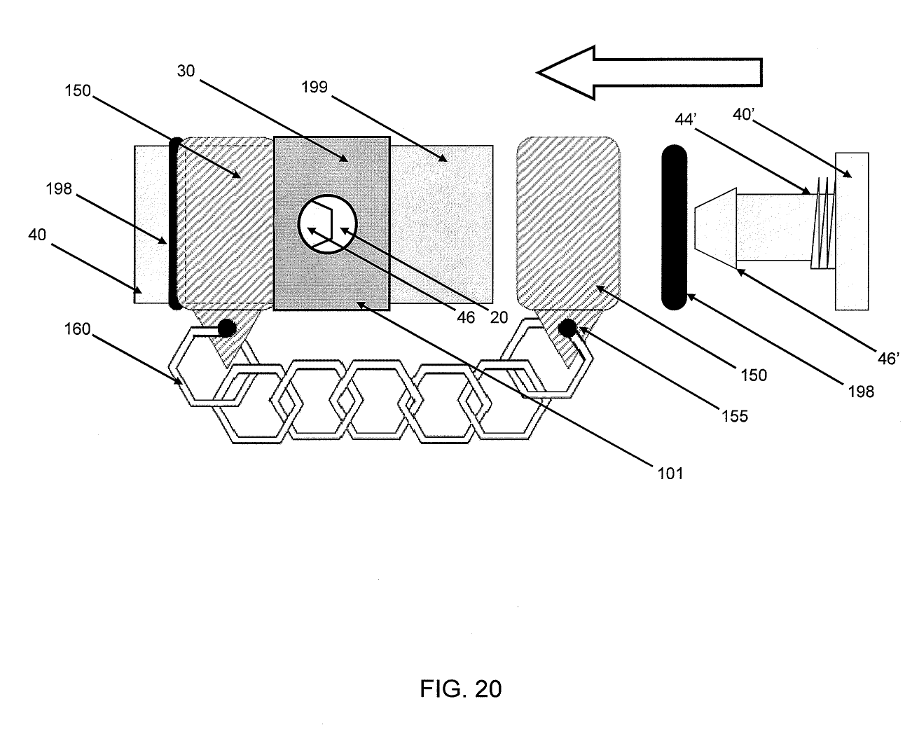

FIGS. 19 and 20 illustrate yet another embodiment the invention. Referring now to FIG. 19 which shows an embodiment of a barrel assembly 101 having two threaded compression screws 40, and corresponding O-rings 198. The illustrated embodiment includes a barrel member 30 having top 62 and bottom sections 64. The bottom section 62 features a first axially disposed, threaded female compression cavity 38 formed therein defining an annular end-face and, a pair of diametrically disposed feed through holes 20 positioned axially along the barrel member 30 intersecting the compression cavity above its base. The top section 62 of the barrel member 30 includes a second, opposing axially disposed, threaded female compression cavity formed therein defining a second annular end-face. Preferably the top and bottom cavities intersect proximate to the feed through holes 20 and define a single large cavity 38 with a threaded portion at each end. The single large cavity 38 is also intersected by the feed through holes 20. In other embodiments each of the cavities extends to just before the feed through holes 20 and one cavity extends substantially beyond the feed through holes while the other terminates substantially before the feed through holes, intersecting near the top or bottom of the barrel member 30.

The device 101 also includes first and second male compression members 40, 40′ each having a threaded base 44, a shaft 42 and a compression tip 46. Each threaded base 44, is preferably dimensioned to fit within, frictionally engage and mate with the threads 36 of the threaded section of the first and second female compression cavities 38 of the barrel member 30. When inserted into the compression cavities, the first male compression member's 40 compression tip 46′ projecting distally from the base relative to the first cavity opening, past the feedthrough holes 20, and the second male compression member's tip 46′ projects distally from the base relative to the second cavity opening, proximate to the feedthrough holes 20.

Preferably, when the first and second male compression members 40, 40′ are inserted at the opposing ends of the barrel member 30 and frictionally engage the barrel cavity the first male compression member 40 compression tip 46 engages a drawstring (not shown) extending diametrically through the feedthrough holes 20 within the barrel cavity 30, compressing the drawstring against the compression tip 46′ of the second male compression member 40′. The engagement of the drawing by the coordinating tips 46, 46′ of the first and second male compression members 40, 40′ affix the barrel member 30 to the drawstring. In embodiments, such as that shown in FIG. 20 employing threaded engagement between the male compression members 40, 40′, or compression screws, and the barrel member 30, the compression screws 40, 40′ are tightened to the point of interlocking engagement of the tips 46, 46′ of the first and second male compression screws 40, 40′ and the drawstring.

In at least one embodiment the barrel member also includes at least one O-ring assembly 198, 198′ disposed between the barrel member 30 and each of the two male compression members, 40, 40′. In this embodiment the device also incorporates a band assembly 150 having at least one mounting tab 155 adapted to receive an accessory chain 160 or other accessory. FIG. 20 shows a front view of the embodiment of the barrel assembly of FIG. 19 featuring a band assembly mounted thereon. As shown in FIG. 20 the first compression screw 40 is illustrated inserted in and in threaded engagement with the barrel member 30, while the second compression screw 40′ is shown prior to insertion. This FIG. also illustrates a band assembly 150 adapted to substantially and concentrically loop the barrel member 30 and affix a mounting tabs 155 to the barrel member 150 for other accessories. The band assembly 150 is disposed around the barrel member 30 proximate to a junction of the barrel member 30, the O-ring 198 and the male compression member 40, 40′. Preferably the O-ring assembly 198 is constructed of a compressible and resilient material.

Upon the frictional interlocking engagement of the barrel member 30 and the male compression members 40, 40′, typically accomplished by screwing the male compression members 40, 40′ into the female cavity of the barrel member 30, the O-rings 198 compress in the vertical plane and deform in the horizontal plane expanding each O-ring's 198 circumference in the horizontal plane. The expansion of the O-ring's circumference causes the O-ring 198 to engage the band assembly 150 seating the band assembly 150 to the barrel member 30. Typically the point of engagement is the bottom surface of the band assembly 150, but in other embodiments the point of engagement may be proximate to the end on the outer surface or edge of the band assembly 150. In this exemplary embodiment the edges of the barrel member 30 are deep-set 199 relative to the center section to receive the band assembly 150, and defining a structural stop in the form of a protruding center section limiting the movement of the band assembly along the barrel member's vertical axis.

Reducing the compression of the O-rings 198 from the frictional interlocking engagement of the barrel member 30 and the male compression screw 40, by unscrewing one or both male compression members 40, 40′, the O-rings 198 return substantially to their original shape, causing the O-rings 198, and ultimately the barrel assembly 101, to disengage the band assembly 150 for removal.

This feature provides demountable attachment of the band assembly 150 and any attached accessory 160, ornamental or otherwise to the barrel assembly 30. This feature allows one select between a plurality of accessories and to easily interchange various accessories by adding or removing them from the barrel assembly 30 without having to disassemble the barrel assembly 101 by removing the male compression members 40, 40′ from the barrel member.

As described the embodiments preferably are selectively mountable and demountable relative to the drawstring. However, it is contemplated herein that the accessory may include features known in the art that may prevent reversibility rendering the embodiment single use; that is, not demountable once applied. Structures accomplishing this aspect are well known and within the ordinary skill of the art.

Although specific example embodiments have been illustrated and described herein, those of ordinary skill in the art appreciate that other variations, aspects, or embodiments may be contemplated, and/or practiced without departing from the scope or the spirit of the appended claims, for example the disclosed apparatus may be used to adjust or secure a drawstring employed to seal or adjust the size of the opening on a tote bag or a similar bag or could be used to secure shoe laces.

I claim:

1. An apparatus for attaching an accessory to a barrel lock assembly comprising:
a band assembly having top and bottom surface, said bottom surface defining the inner band ring, said inner ring being sized to receive a barrel lock assembly therethrough, said band assembly having an accessory mounting tab disposed on said top surface, a pivoting joint, and a void formed in said top surface, said void defining a hole extending through said band assembly;
a pivoting lock clip, said pivoting lock clip having a first edge and a second edge, and a seating element formed thereon proximate to said second edge protruding from a surface of said lock clip in the direction of said band assembly top surface, said pivoting lock clip being disposed proximate to the top surface of said band assembly and having said first edge being secured to said pivoting joint formed on top surface of said band assembly such that said pivoting lock clip can rotationally pivot about the pivoting joint in plane defined by said band assembly between an open position and a closed position,
wherein said seating element formed on said pivoting lock clip projects through the hole in said band assembly and into the inner band ring engaging a barrel lock assembly inserted in said band assembly and seating said band assembly to said barrel lock when the pivoting lock clips is in the closed position.

2. The apparatus of claim 1 wherein said seating element formed on said pivoting lock clip does not protrude into said inner band ring when said pivoting lock clip is in the open position, allowing said band assembly to be removed from said barrel lock.

3. The apparatus of claim 1 wherein said band assembly includes a plurality of accessory mounting tabs disposed on said top surface.

4. The apparatus of claim 1 wherein said band assembly forms a complete ring around the perimeter of said barrel lock assembly when said band assembly is seated to said barrel lock assembly.

5. The apparatus of claim 1 wherein said band assembly forms a partial ring around the perimeter of said barrel lock assembly when said band assembly is seated to said barrel lock assembly.

6. The apparatus of claim 1 wherein said seating element is adapted to engage a corresponding structure on said barrel assembly to lock said pivoting lock clip in the closed position and lock said band assembly to said barrel assembly.

7. An apparatus for attaching an accessory to a barrel lock assembly comprising:
a band assembly having top and bottom surface, said bottom surface defining the inner band ring, said inner ring being sized to receive a barrel lock assembly therethrough, said band assembly having an accessory mounting tab disposed on said top surface;
a means for fastening said band assembly onto said barrel lock assembly;
wherein said means for fastening said band assembly onto said barrel lock assembly reduces the size of the inner ring assembly causing said band assembly to engage said barrel assembly in a clamping action.

8. The apparatus of claim 7 wherein said band assembly further comprises a seating element, said seating element being adapted to engage the barrel lock assembly and affix the position of the band assembly on the barrel lock assembly in at least one plane of motion.

9. An apparatus for the attachment of an accessory to a drawstring comprising:
a barrel member having an axially disposed, female, compression cavity formed in one end defining an annular end-face and a pair of diametrically disposed feed through holes, positioned axially along the body so as to intersect said barrel cavity above its base; said feedthrough holes being sized to receive and allow a drawstring or the like to pass into the barrel, through said barrel cavity and exit said barrel;
said barrel member further having at least one accessory mounting tab disposed on the outer surface of the barrel body having a tab surface that projects out from the outer surface of said barrel body, said accessory mounting tab being incorporated into a band assembly that substantially and concentrically loops said barrel member and demountably affixes said mounting tab to said barrel member, said tab surface having a hole therein to engage an accessory;
a compression member dimensioned to fit within and mate with said female compression cavity of said barrel member, said compression member having a compression tip projecting distally of said feedthrough holes relative to said cavity opening wherein the length of said compression member is less than that of said cavity but upon insertion and frictional interlocking engagement of said male compression member into said cavity, said male member engages and compress a drawstring extending diametrically through said feedthrough holes, positionally affixing said barrel on said drawstring.

10. The apparatus of claim 9 wherein said band assembly demonuntably engages a surface of said barrel member in a clamping action.

11. The apparatus of claim 9 wherein said barrel assembly includes at least one pair of protruding stop assemblies disposed on the surface of said barrel assembly proximate to the outside edges of each of said at least one band assembly to retain said band assembly on said barrel assembly.

12. The apparatus of claim 11 wherein said at least one pair protruding stop assemblies are ring assemblies that protrude from to barrel surface and define the range of slidable engagement of the band assembly on the barrel assembly in at lest one plane of motion.

13. An apparatus for the adjustable attachment of an accessory to a clothing string comprising:
a barrel member having a top and bottom section, said bottom section having a first axially disposed, threaded female compression cavity formed therein defining an annular end-face and, a pair of diametrically disposed feed through holes positioned axially along the barrel member intersecting the compression cavity above its base, said top section of said barrel member having a second axially disposed, threaded female compression cavity formed therein defining a second annular end-face in the top extending to said bottom cavity above the said feed through holes;
a first male compression member having a base, a shaft having a threaded portion and a compression tip, said base dimensioned to fit within and frictionally engage and mate with said first female compression cavity of the barrel member, said compression tip projecting distally from said base relative to the cavity opening, past said feedthrough holes;
a second male compression member having a base, a shaft having a threaded portion and a compression tip, said base dimensioned to fit within and frictionally engage and mate with the second female compression cavity of the barrel member, said compression tip projecting distally from said base relative to the cavity opening, proximate to said feedthrough holes;
wherein upon insertion and frictional interlocking engagement of said first and second male compression member and said barrel cavity said first male compression member engages a drawstring extending diametrically through said feedthrough holes within said barrel cavity, compressing said drawstring against said compression tip of said second male compression member affixing said barrel member to said drawstring.

14. The device of claim 13 wherein said barrel member has at least one O-ring assembly disposed between said barrel member at least one male compression member.

15. The device of claim 14 further comprising a band assembly having at least one mounting tab, said band assembly adapted to substantially and concentrically loop said barrel member and affix said mounting tab to said barrel member, said band assembly being disposed around said barrel member proximate to a junction of said barrel member, said at least one O-ring and said at least one male compression member;
wherein said frictional interlocking engagement of said barrel member and said at least one male compression member compresses said at least one O-ring in a first plane and deforms said at least one O-ring in a second plane by expanding said at least one O-ring's circumference in said second plane such that said at least one O-ring engages said band assembly and seats said band assembly to said barrel member.

16. The device of claim 15 wherein said at least one O-ring assembly is constructed of a compressible and resilient material, wherein reducing the compression of said at least one O-ring from said frictional interlocking engagement of said barrel member and said male compression member said at least one O-ring returns to its original circumference in said second plane disengaging said band assembly providing demountable attachment of said band assembly to said barrel assembly.

17. The device of claim 13 wherein said barrel member has plurality of deformable molded keys disposed in said first female compression cavity below said feedthrough holes, said molded keys projecting radially from said cavity surface, and at least one of said male compression members having a compression tip that having a slightly greater diameter than the diameter of the interior cavity defined by said plurality of molded keys in the bottom section of said barrel member.

18. The device of claim 17 wherein said barrel member has plurality of deformable molded keys disposed in said second female compression cavity above said feedthrough holes, said molded keys projecting radially from said cavity surface, and at least one of said male compression members having a compression tip that having a slightly greater diameter than the diameter of the interior cavity defined by said plurality of molded keys in the top section of said barrel member.
